(19) United States
(12) Patent Application Publication
(10) Pub. No.: US 2014/0095251 A1
(43) Pub. Date: Apr. 3, 2014

(54) Methods and Systems for Optimizing Marketing Strategy to Customers or Prospective Customers of a Financial Institution

(71) Applicant: Citicorp Credit Services, Inc., (US)

(72) Inventor: Sami Huovilainen, New York, NY (US)

(73) Assignee: Citicorp Credit Services, Inc., Long Island, NY (US)

(21) Appl. No.: 13/644,124

(22) Filed: Oct. 3, 2012

(51) Int. Cl. G06Q 30/02

(52) U.S. Cl. 705/7.29

(57) ABSTRACT

Methods and systems for optimizing marketing strategy to financial institution customers or prospective customers employ a processor coupled to memory and other computer hardware and software components for receiving customer profile data with a plurality of transaction card issuers other than the financial institution, developing models based at least in part on the customer profile data and at least in part on financial institution customer account and credit data, and generating estimated spend and balance behaviors for at least one financial institution customer with the plurality of transaction card issuers other than the financial institution based at least in part on said models. Based at least in part on the estimated spend and balance behaviors, financial institution marketing initiatives are created.

### FIELD OF THE INVENTION

The present invention relates generally to the field of analyzing customer data, and more particularly to methods and systems for optimizing marketing strategy to financial institution customers or prospective customers.

### BACKGROUND OF THE INVENTION

In pursuing growth, for example, within the transaction card business, it is important for a card-issuing financial institution, such as a bank, to focus on a customer perspective and to know more about its customers. What the financial institution already knows about its customers is the data that is shared with the financial institution when those customers use their financial institution-issued cards. Thus, when customers make transactions with their financial institution-issued cards, the financial institution knows where those transaction take place, how much is spent in the transactions and how those customers pay their bills. In addition, the financial institution may also acquire credit bureau information on its customers with respect to various financial behaviors with other card issuers, such as how many trades they have with other banks, how much in mortgage indebtedness they have, and what types of balance levels they may have with other banks.

There is a present need for methods and systems for optimizing marketing strategy to financial institution customers or prospective customers, that address a financial institution's need to know how its customers use off-us bankcards and provides the financial institution a comprehensive view of its customers' spend and balance behavior with other issuers.

### SUMMARY OF THE INVENTION

Embodiments of the invention employ computer hardware and software, including, without limitation, one or more processors coupled to memory and non-transitory computer-readable storage media with one or more executable programs stored thereon which instruct the processors to perform the methods and systems for optimizing marketing strategy to financial institution customers or prospective customers, described herein.

Embodiments of the invention may provide methods for optimizing marketing strategy to financial institution customers or prospective customers, that may involve, for example, receiving, using a processor coupled to memory, customer profile data with a plurality of transaction card issuers other than the financial institution; developing, using the processor, models based at least in part on the customer profile data and at least in part on financial institution customer account and credit data; generating, using the processor, estimated spend and balance behaviors for at least one financial institution customer with the plurality of transaction card issuers other than the financial institution based at least in part on said models; and creating, using the processor, financial institution marketing initiatives based at least in part on said estimated spend and balance behaviors.

In an aspect of embodiments of the invention, receiving the customer profile data may involve, for example, receiving estimated values of customer behaviors with a plurality of transaction card issuers other than the financial institution. In another aspect, receiving the estimated values of customer behaviors may involve, for example, receiving estimated values of customer overall and category level spend behaviors and revolving balances by annual percentage rate behaviors with a plurality of transaction card issuers other than the financial institution. In an additional aspect, developing the models may involve, for example, modeling values of customer behaviors in the customer profile data as a function of the financial institution customer account and credit data.

In an additional aspect of embodiments of the invention, modeling the values of the customer behaviors may involve, for example, modeling values of customers' spend and lend behaviors with the plurality of transaction card issuers other than the financial institution. In a further aspect, modeling the values of the customers' spend behaviors may involve, for example, modeling the values of the customers' spend behaviors consisting of customers' total spend with the plurality of transaction card issuers other than the financial institution, customers' spend in categories consisting of everyday, travel, retail, online, and foreign spend with the plurality of transaction card issuers other than the financial institution, and customers' spend with airline co-branded products, other co-branded products, reward products, and non-reward products with the plurality of transaction card issuers other than the financial institution.

In another aspect of embodiments of the invention, modeling the values of the customers' lend behaviors may involve, for example, modeling the values of the customers' lend behaviors consisting of customers' total revolving balance with the plurality of transaction card issuers other than the financial institution, customers' amount of revolving balance by promotional rate, full rate, and higher rate with the plurality of transaction card issuers other than the financial institution, customer' estimated annual percentage rate of revolving balance with the plurality of transaction card issuers other than the financial institution, and customers' total revolving balance with airline co-branded products, other co-branded products, rewards products, and non-rewards products with the plurality of transaction card issuers other than the financial institution.

In a further aspect of embodiments of the invention, generating the estimated spend and balance behaviors may involve, for example, generating estimated spend, lend, and value proposition behaviors for said at least one financial institution customer with the plurality of transaction card issuers other than the financial institution based at least in part on said models. In addition, generating the estimated spend behaviors may involve, for example, generating the estimated spend behaviors at category and value proposition level for said at least one financial institution customer with the plurality of transaction card issuers other than the financial institution based at least in part on said models. Further, generating the estimated balance behaviors may involve, for example, generating estimated lend behaviors by price point and value proposition for said at least one financial institution customer with the plurality of transaction card issuers other than the financial institution based at least in part on said models.

In still further aspects of embodiments of the invention, generating the estimated spend and balance behaviors may involve, for example, generating the estimated spend and balance behaviors for said at least one financial institution customer with the plurality of transaction card issuers other than the financial institution based at least in part on modeling attributes derived from said at least one customer's current month and time-series credit data. Additionally, generating the estimated spend and balance behaviors based at least in part on said modeling attributes derived from the customer's time-series credit data may involve, for example, generating the estimated spend and balance behaviors for said at least one financial institution customer with the plurality of said issuers other than the financial institution based at least in part on modeling attributes derived from said at least one customer's time-series credit data across a six months period. Further, generating the estimated spend and balance behaviors based at least in part on said modeling attributes derived from said at least one customer's current month and time-series credit data may involve, for example, generating the estimated spend and balance behaviors based at least in part on modeling attributes consisting of said at least one customer's number of bankcards, open trades with balance greater than zero, six month minimum to maximum ratio of highest utilization of revolving trades, retail annual percentage rate on trades, and number of tradelines exceeding thirty days.

In other aspects, creating financial institution marketing initiatives may involve, for example, creating an individual marketing initiative tailored for said at least one customer based at least in part on said estimated spend and balance behaviors. In addition, creating the individual marketing initiative may involve, for example, creating the individual marketing initiative for each one of a plurality of customers based at least in part on said estimated spend and balance behaviors for each one of said customers.

Other embodiments of the invention may provide systems for optimizing marketing strategy to financial institution customers that involve, for example, a processor coupled to memory, the processor being programmed to receive customer profile data with a plurality of transaction card issuers other than the financial institution; develop models based at least in part on the customer profile data and at least in part on financial institution customer account and credit data; generate estimated spend and balance behaviors for at least one financial institution customer with the plurality of transaction card issuers other than the financial institution based at least in part on said models; and create financial institution marketing initiatives based at least in part on said estimated spend and balance behaviors.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a flow chart which illustrates an example of the process of generating predicted “Y” variables for embodiments of the invention;

FIG. 2 is a flow chart which illustrates an example of the process of modeling using predictor “X” variables for embodiments of the invention;

FIG. 3 is a table that illustrates examples of predicted “Y” variables on the spend side for embodiments of the invention;

FIG. 4 is a table that illustrates examples of predicted “Y” variables on the lend side for embodiments of the invention;

FIG. 5 is a flow chart which illustrates an example of the process of building modeling attributes for embodiments of the invention;

FIG. 6 is a flow chart which illustrates model outcomes and marketing actions for embodiments of the invention; and

FIG. 7 is a flow chart that illustrates an example of the process of optimizing marketing strategy to financial institution customers or prospective customers, for embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

Embodiments of the invention provide methods and systems for optimizing marketing strategy to financial institution customers or prospective customers, that enable the financial institution to have a comprehensive view of its customers' spend and balance behavior with other issuers. Thus, embodiments of the invention provide the financial institution a full view into customers' off-us spend at category and value proposition levels and their off-us lend behavior by price point and value proposition. For example, embodiments of the invention may tell the financial institution in what spend categories its customers spend with off-us cards. Embodiments of the invention provide answers to the financial institution to questions, such as whether or not its customers spend using its competitors' cards in everyday spends, such as in grocery stores, at retailers, on travel, or in online shopping, or whether or not they use its competitors' cards, for example, mainly for travel.

Such information is very valuable information to the financial institution because it may tell the financial institution about the existence of a possible gap, such as a particular set of features in the financial institution's products, that may be leading its customers to put their spends on the cards of its competitors. Based on that information, the financial institution may be able to target those customers with special promotions in particular categories to address the gap. Further, the financial institution may use the information for enhancing its value proposition so that its customers will use the financial institution-issued cards in those categories in the future.

While the financial institution may prefer to rely less on the lend business, it is still obviously a very important part of the financial institution's business, and embodiments of the invention also enable the financial institution to tell how its customers borrow with its competitors' credit cards. As previously noted, the financial institution can tell from its own customers' data how much its customers are currently revolving every month, what price they are paying the financial institution to do so, and how its customers are paying down amounts owed on its financial institution-issued cards.

However, embodiments of the invention may also allow the financial institution to determine the balance amounts that its customers have at each price point with non-financial institution-issued credit cards. That information is valuable to the financial institution because it tells the financial institution, for example, what kinds of price points customers may find attractive and whether particular customers are lenders or spenders. A very important point relates to the fact that customers use particular cards because of the value proposition represented by such cards.

Embodiments of the invention enable the financial institution to identify value propositions that its customers may be finding attractive in using its competitors cards. For example, at a broad category level, embodiments of the invention may enable the financial institution to know whether its customers are using off-us cards co-branded with an airline, off-us cards co-branded with a non-airline entity, off-us rewards cards, or off-us non-rewards cards. Such information may be valuable to the financial institution for the insight it may provide in considering how the financial institution may grow its spend portfolio.

For example, if customers are charging their travel spend on competitors' cards co-branded with an airline instead of its competitors' non-rewards cards, the financial institution may want to consider the issue of its relationship with the particular airline with which its own card may be co-branded. On considering that issue, the financial institution may take a different marketing action based on the insight provided by that type of information

Knowledge of the behavior of the customers of the financial institution with other card issuers with respect to off-us spends, off-us lends, and the value propositions may provide a “full wallet” capability for the financial institution. Such full wallet capability may allow the financial institution to know exactly how its customers are using its competitor's card, which information may be of great value to the financial institution from a marketing perspective.

Obviously, the financial institution's knowledge of its customers' behavior with its competitors' cards is not directly available to the financial information in the form of specific account or transaction information. However, embodiments of the invention may provide such knowledge indirectly. For example, an aspect of embodiments of the invention may involve use of anonymous data received from an entity that analyzes customer profiles from card issuers for a significant percentage, such as approximately 95 percent, of all cardholders in the United States, including cardholders of off-us cards. Another aspect of embodiments of the invention may involve using the financial institution's own account information, as well as non-anonymous credit bureau data for all of its own customers and prospects.

Embodiments of the invention may also employ statistical tools and estimators utilizing both the financial institution information and other card issuers' information to derive variables. An important aspect of embodiments of the invention is use of the anonymous customer profile data received from the entity which information may be used to develop and train models that may be deployed to estimate the behavior of the customers of the financial institution with other card issuers. From an accuracy perspective, the estimator aspect for embodiments of the invention meets strict statistical requirements and provides results of great value to the financial institution.

The models employed by embodiments of the invention may include one or more statistical models that complete the full wallet capability and the off-us customer view for the financial institution. Such models may enable the financial institution to understand, for example, what cards may be in its own customers' wallets other than cards issued by the financial institution. Utilizing data that is available to the financial institution, for example, from the financial institutions' own internal data and from credit bureaus, the financial institution may complete a reasonable, but not a complete, picture of its customers.

For example, from its own internal data, the financial institution may be able to learn how its customers spend using on-us cards and how and at what price points its customers revolve with on-us cards. The financial institution may also be able to learn from its own internal data how its customers react to different marketing efforts of the financial institution. From the credit bureau data, the financial institution may also be able to learn, for example, what kinds of balances its customers hold with cards issued by other card issuers and how many lines of credit its customers have with other card issuers.

However, the financial institution cannot tell from the credit bureau data anything about its customers' actual usage of credit cards issued by other card issuers. The financial institution simply cannot tell from its own internal data or from the credit bureau data where its customers shop or how and at what price points they may revolve using cards issued by other card issuers. Thus, the variables received or obtained by the financial institution from the credit bureau are limited in respect to information about its customers' shopping behavior.

While the credit bureau data may tell the financial institution, for example, about its customers' delinquencies with other issuers, their overall balances, their credit lines or limits, their mortgages, and their auto loans, it cannot tell the financial institution anything about how its customers are shopping using its competitors' cards. This is because the information reported by each card issuer to the credit bureaus is limited, for example, to trade or credit lines and the total balances on those tradelines for a given month, which includes both the spend and revolving balance components without breaking the balances down into those components. Therefore, simply looking at the balance variable received from the credit bureaus tells the financial institution nothing about how much of those balances are revolving versus spend.

However, embodiments of the invention enable the financial institution to understand how much its customers may actually be spending and revolving using its competitors' cards. Currently, one or more entities in the United States may perform a service of analyzing data submitted by multiple card issuers and generating customer profiles to such card issuers with competitive reports based on its analysis. Such reports may tell a card issuer how its portfolio is performing in comparison to other card issuers in terms, for example, of spend and profitability.

Embodiments of the invention may involve, for example, statistical modeling based on those customer profiles to estimate how customers use their cards in each of multiple spend categories, such as everyday spend, travel spend, retail spend, online spend, and foreign spend, and high value propositions by those items. That does not mean that cardholder account information from any card issuer for an account that exhibits certain behavior is shared with or disclosed to any other card issuer.

Instead, embodiments of the invention may involve a statistical model that may be used apart from any actual cardholder account information from other card issuers to estimate those behaviors. Thus, the data that is used in developing those models may be data to which the financial institution has full access. That data may include, for example, financial institution account data, credit bureau data and models developed from customer profile data of multiple card issuers.

Embodiments of the invention may utilize all of those attributes to run the models developed from the pool data from multiple card issuers to provide a view into overall customer behavior. In doing so, embodiments of the invention may use the data to which the financial institution already has access, such as the on-us and credit bureau data, to fill models. For example, using models, if a cardholder has a balance of x dollars on the cardholder's account with the financial institution and behaves in a certain way based on the cardholder's credit bureau file, it is most likely that the cardholder may also have an off-us spend of y dollars.

Thus in embodiments of the invention, all of the models are built on data to which the financial institution may already have access and which may be used in estimating models based on that data to estimate its cardholders' off-us spend and off-us revolve and to provide a complete picture of a cardholders' behavior. Embodiments of the invention may be characterized as similar to a jigsaw puzzle where all of the lend and spend information comes together and enables the financial institution to tell exactly how its customers are using its cards versus cards issued by other card issuers and to provide a picture that the credit bureau cannot currently provide.

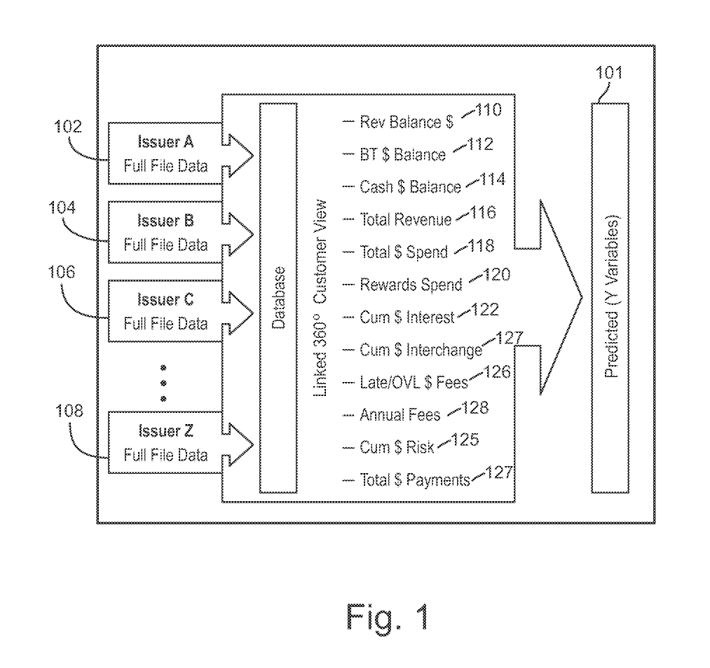

FIG. 1 is a flow chart which illustrates an example of the process of generating predicted “Y” variables 101 for embodiments of the invention. Referring to FIG. 1, according to embodiments of the invention, information such as full file data 102, 104, 106, 108 may be received periodically, such as each month, from most card issuers in the United States and uploaded to a database of an entity that analyzes data submitted by multiple card issuers and generates customer profiles to such card issuers. Thus, the database contains variables such as the exact behavior of every credit card customer with respect to revolving balances 110, balance transfers 112, cash advance balances 114, profitability 116, total spend 118, rewards spend 120, interest 122, interchange fees 124, late and over limit fees 126, and annual fees 128 in every single transaction performed by each and every cardholder of such card issuers.

Assume, for example, that a financial institution cardholder also happened to be a cardholder of another card issuer, and assume further that the cardholder booked two airline tickets, charging one ticket to each card of the cardholder. While it may be obvious from the information in the database that the cardholder purchased two tickets using two different cards of two different card issuers, based only on information readily available to the financial institution the financial institution may know only that its cardholder purchased one ticket with the financial institution-issued card and perhaps had a change in balance according to credit bureau information. The financial institution has no way of knowing, based solely on its own data and credit bureau data, that the cardholder purchased a second airline ticket using a card issued by another card issuer.

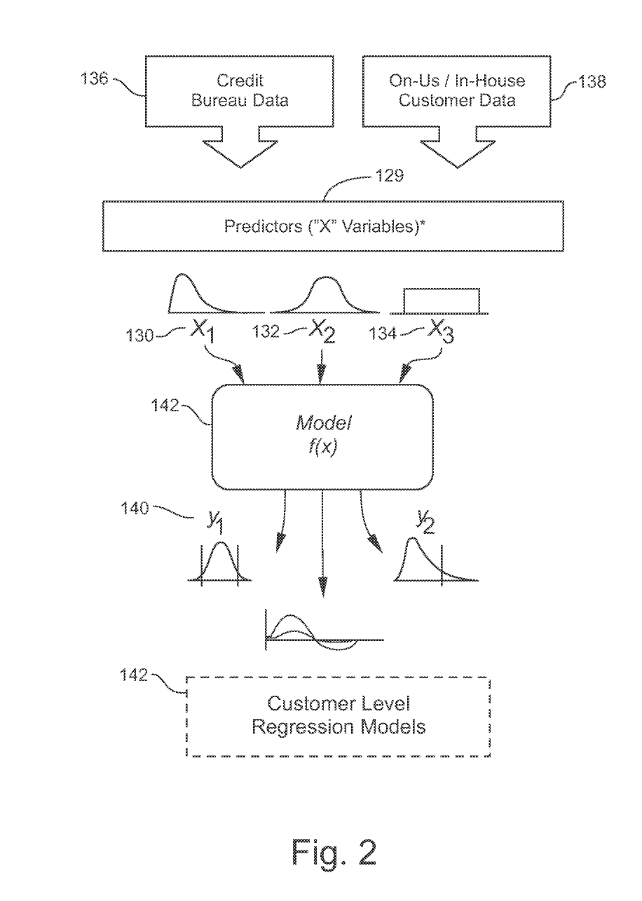

FIG. 2 is a flow chart which illustrates an example of the process of modeling using predictor “X” variables 129 for embodiments of the invention. Referring to FIG. 2, embodiments of the invention utilize predictors or “X” variables 129, such as X₁ 130, X₂ 132, and X₃ 134, to which the financial institution may have access, to estimate customer behaviors. In embodiments of the invention, no variables to which only an entity other than the financial institution may have access are used in estimating customer behaviors. The data to which the financial institution has access may include, for example, credit bureau data 136 and financial institution in-house customer account data 138. Thus, the financial institution knows where its customers spend.

An example of a customer phenomenon that has been observed in models for embodiments of the invention in estimating total spend may be characterized as “once a high spender, always a high spender”. Thus, a financial institution cardholder who is a very heavy transactor and a relatively high spender using a card issued by the financial institution may be more likely to be a heavy transactor and high spender using a card issued by another card issuer. It may be seen that, based on data to which the financial institution has access, if the financial institution's in-house customer account data identifies a particular customer as a heavy transactor using an on-us card, it may be more likely that the same customer may also be a heavy transactor using a card issued by another card issuer.

Another example of a customer phenomenon observed in models for embodiments of the invention is that customer data, including the credit bureau data 136 to which the financial institution has access, that is indicative of a certain overall type of balance volatility may tend to be predictive of customer spends rather than customer lends. Thus, when total balances 118 with certain volatilities are observed in such data, it may be inferred and estimated with a high level of accuracy that those balances actually represent spending rather than lending. Examples of predictors or “X” variables 129, X₁ 130, X₂ 132, and X₃ 134, for embodiments of the invention include a customer's on-us spend amount, whether a customer is a transactor or revolver with the customer's on-us account, or a customer's coefficient of variation of the customer's credit bureau balance amount over a period of time, such as in the preceding six months.

Many of such behavioral attributes, such as the overall credit bureau balance level, may be powerful predictors. For example, if a customer has absolutely no credit bureau balances whatsoever, models are not needed to say that the customer probably does not spend with credit cards issued by other issuers. However, if the customer has a balance of $1,000 with another card issuer, in all likelihood that balance may not be all revolving, but it is not readily apparent what portion of that balance is spend and what portion of the balance is lend. The models for embodiments of the invention enable the financial institution to estimate those portions. As previously mentioned, one of the predictors or “X” variables 129 may be the monthly volatility or variation of the customers balance over time. A very high volatility may tend to indicate that the balance is spend, but a relatively flat volatility may tend to indicate a revolving balance. In embodiments of the invention, the customer's behavior may be modeled as a combination of the predictors or “X” variables 129.

In embodiments of the invention, predicted or “Y” variables 101 are all potential variables on which models for embodiments of the invention may be built to replicate information that was uploaded to the database. Thus, embodiments of the invention enable building a model, for example, for revolving balance 110, balance transfer 112, cash balance 114, total revenue 116, total spend 118, rewards spend 120, cumulative interest 122, cumulative interchange fees 124, late or over limit fees 126, annual fees 128, cumulative risk 125, and total payments 127.

In embodiments of the invention, the particular predictor or “X” variable 129 that goes into estimating a particular “Y” or predicted variable 101 may be based on data to which the financial institution has access, such as credit bureau data 136 and in-house customer account data 138. For example, an outcome of X₁ 130, X₂ 132, and X₃ 134 may be a prediction of an estimate of Y₁ 140, which may be a revolving balance amount 110. Thus, a particular “Y” variable 101 may be a function 142 of whatever “X” variables 124 that are used.

Embodiments of the invention may utilize different functional forms, such as generalized linear models, examples of which may include customer level regression models 142, in the predictive process. Embodiments of the invention also involve different types of models. For example, a predicted or “Y” variable 101 may be a probability model such as a probability of a customer using a card of another card issuer co-branded with an airline. In an example of a generalized linear model for embodiments of the invention, a predicted or “Y” variable 101 may be a total amount of spend with all other issuers. In that case, the distribution may be different because it is a different predicted or “Y” variable 101.

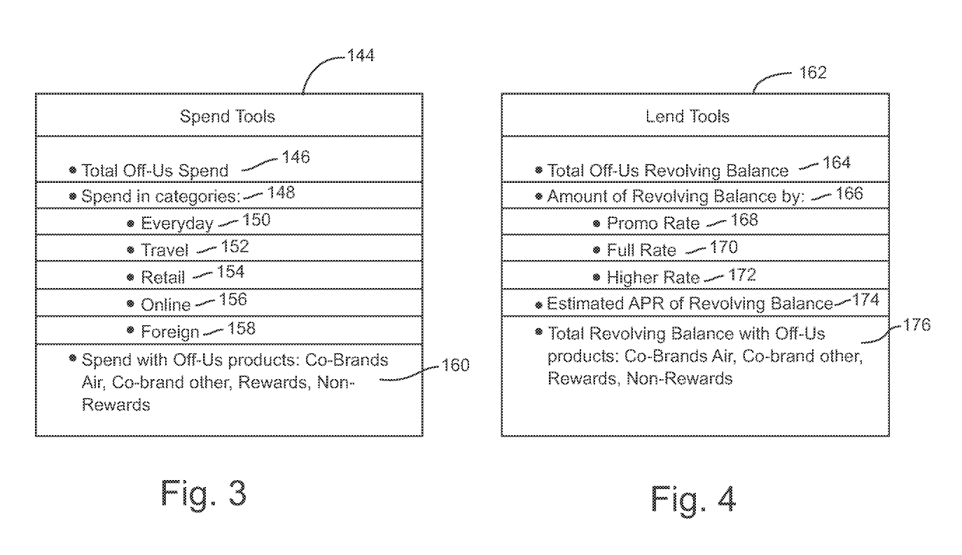

FIG. 3 is a table that illustrates examples of predicted “Y” variables 101 on the spend side for embodiments of the invention. Referring to FIG. 3, examples of predicted or “Y” variables 101 on the “spend tools” 144 side may include total off-us spend 146, spend in categories 148 of total everyday spend 150, travel spend 152, retail spend 154, online spend 156, foreign spend 158, and also spend associated with off-us products 160, such as off-us airline co-branded cards, other off-us co-branded cards, off-us rewards cards, and off-us non-rewards cards.

FIG. 4 is a table that illustrates examples of predicted “Y” variables 101 on the lend side 162 for embodiments of the invention. Referring to FIG. 4, examples of predicted or “Y” variables 101 on the “lend tools” side 162 may include total off-us revolving balance 166, amount of revolving balance by promotional rate 168, full rate 170, or higher rate 172, estimated annual percentage rate on revolving balance 174, and total revolving balance with off-us products 176 such as such as off-us airline co-branded cards, other off-us co-branded cards, off-us rewards cards, and off-us non-rewards cards.

Embodiments of the invention may involve, for example, sets of models to predict each one of those predicted or “Y” variables 101. Based on those statistical models and what is predictive for each of these “Y” variables 101, embodiments of the invention may involve scoring each and every one of the financial institution's customers with a score which can be utilized in marketing actions.

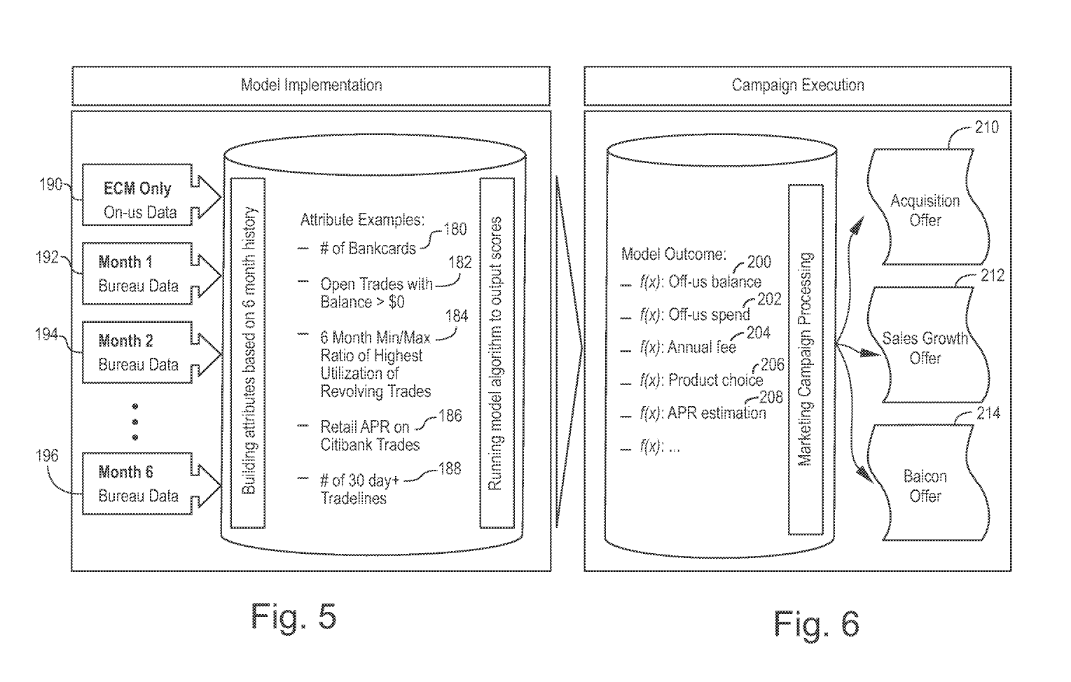

FIG. 5 is a flow chart which illustrates an example of the process of building modeling attributes. Referring to FIG. 5, an aspect of embodiments of the invention may involve, for example, building modeling attributes based on data for a predetermined period of time, such as six months. Examples of such modeling attributes may include, for example, customers' number of bankcards 180, open trades with balances greater than zero 182, six month minimum to maximum ratio of highest utilization of revolving trades 184, retail annual percentage rate on trades 186, and number of tradelines exceeding thirty days for said customers 188. In such aspect, everything that is done by each one the financial institution's customers can be known from on-us customer account data stored on a financial institution database. In addition, such aspect may also involve considering all of the credit bureau data for a current month 190, for the immediately preceding month 192 and for each month before that 194 up to a predetermined number of months, such as a total of six months 196, preceding the current month 190.

The models for embodiments of the invention may be implemented with the financial institution's on-us customer account data and the current and preceding six months of credit bureau data. Based on such data, for example, a coefficient of variation of a customer's credit bureau balance in the preceding six months may be computed. Thereafter, taking the customer's spends with the financial institution during that time period, values of each “Y” or predicted variable 101 may be calculated using the data for every month. FIG. 6 is a flow chart which illustrates model outcomes and marketing actions for embodiments of the invention. The outcome for the models according to embodiments of the invention may include, for example, off-us balance 200, off-us spend 201, the annual fees 204, product choices 206, and annual percentage rate estimation 208, which may then be used for marketing actions. Such marketing actions may include, for example, acquisition offers 210, sales growth offers 212, and balcon (i.e., balance transfer) offers 214. Thus, models for embodiments of the invention may drive marketing actions.

In embodiments of the invention, examples of implementation of such marketing actions may involve, for example, when it is seen that a customer does not have any everyday spend with an on-us card but instead uses an off-us rewards card for everyday spend, the financial institution may consider recommending to its product managers to offer the financial institution's rewards card to the customer. Another marketing action may be to consider giving the customer an “everyday spend accelerator” for a period of time, such as three months, for example, to award three times the number of rewards points or some cash back amount if the customer uses the on-us card for everyday spends during that time.

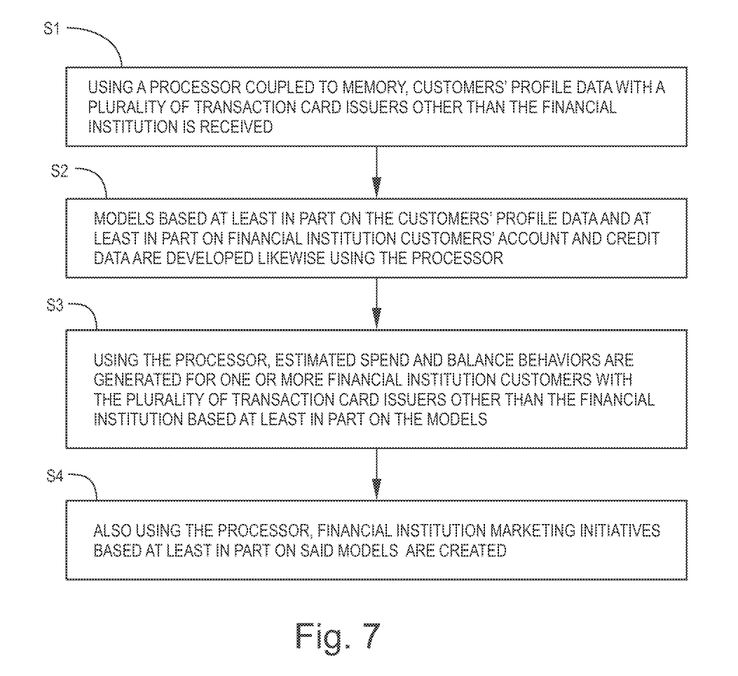

FIG. 7 is a flow chart that illustrates an example of the process of optimizing marketing strategy to financial institution customers or prospective customers, for embodiments of the invention. Referring to FIG. 7, at S1, using a processor coupled to memory, customer profile data with a plurality of transaction card issuers other than the financial institution is received. At S2, models based at least in part on the customers'profile data and at least in part on financial institution customers' account and credit data are developed likewise using the processor. At S3, estimated spend and balance behaviors are generated for at least one financial institution customer with the plurality of transaction card issuers other than the financial institution based at least in part on said models also using the processor. At S4, also using the processor, financial institution marketing initiatives are created based at least in part on said estimated spend and balance behaviors.

In embodiments of the invention, an individual customer may be selected for such marketing action based on the particular customer's predicted behavior according to the sets of statistical models. Thus, for every account, the credit bureau data and the way in which the customer is using the customer's on-us account may be considered and combined with the customer's on-us and off-us behavior in order to tailor a marketing action for the customer. In embodiments of the invention, the models may be scored on an individual customer basis with a score output, which is an estimator of the “Y” or predicted variable 101. It is to be understood that while multiple customers may receive the same treatment based on the model outcomes for embodiments of the invention, they receive the same treatment because of their individual behavior and not as a part of a group.

Depending on marketing capability, a much larger, more diverse set of treatments may be offered to customers. The tools for embodiments of the invention not only allow the financial institution to determine what is going on in its customers' wallets, but also allow the financial institution to understand how to compete for its own customers' wallets. Thus, embodiments of the invention may enable a marketing function of the financial institution to develop a comprehensive set of offers that may allow the financial institution to touch all of its customers and to develop offers that are attractive to the customers as well as to the financial institution.

It is to be understood that embodiments of the invention may be implemented as processes of a computer program product, each process of which is operable on one or more processors either alone on a single physical platform, such as a personal computer, or across a plurality of platforms, such as a system or network, including networks such as the Internet, an intranet, a WAN, a LAN, a cellular network, or any other suitable network. Embodiments of the invention may employ client devices that may each comprise a computer-readable medium, including but not limited to, random access memory (RAM) coupled to a processor. The processor may execute computer-executable program instructions stored in memory. Such processors may include, but are not limited to, a microprocessor, an application specific integrated circuit (ASIC), and or state machines. Such processors may comprise, or may be in communication with, media, such as computer-readable media, which stores instructions that, when executed by the processor, cause the processor to perform one or more of the steps described herein.

It is also to be understood that such computer-readable media may include, but are not limited to, electronic, optical, magnetic, RFID, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, or other transmission device or channel, both wired or wireless. Such instructions may comprise code from any suitable computer programming language including, without limitation, C, C++, C#, Visual Basic, Java, Python, Perl, and JavaScript.

It is to be further understood that client devices that may be employed by embodiments of the invention may also comprise a number of external or internal devices, such as a mouse, a CD-ROM, DVD, keyboard, display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a random access memory (RAM). Such server devices, which may be a single computer system, may also be implemented as a network of computer processors. Examples of such server devices are servers, mainframe computers, networked computers, a processor-based device, and similar types of systems and devices.

1. A method of optimizing marketing strategy to financial institution customers or prospective customers, comprising:
receiving, using a processor coupled to memory, anonymous financial institution customer profile data consisting at least in part of anonymous transaction card account behavior information with a plurality of transaction card issuers other than the financial institution;
developing, using the processor, models based at least in part on the anonymous financial institution customer profile data consisting at least in part of the anonymous transaction card account behavior information with the plurality of transaction card issuers other than the financial institution and at least in part on non-anonymous financial institution customer account information and non-anonymous financial institution customer credit bureau data;
generating, using the processor, estimated spend and balance behaviors for at least one financial institution customer with the plurality of transaction card issuers other than the financial institution based at least in part on said models; and
creating, using the processor, financial institution marketing initiatives based at least in part on said estimated spend and balance behaviors of the at least one financial institution customer with the plurality of transaction card issuers other than the financial institution.

2. The method of claim 1, wherein receiving the anonymous customer transaction card account behavior information further comprises receiving values of anonymous customer transaction card account spend and balance behaviors with a plurality of transaction card issuers other than the financial institution.

3. The method of claim 2, wherein receiving the anonymous financial institution customer transaction card account spend and balance behaviors further comprises receiving values of anonymous financial institution customer transaction card account overall and category level spend behaviors and revolving balances by annual percentage rate behaviors with a plurality of transaction card issuers other than the financial institution.

4. The method of claim 1, wherein developing the models further comprises modeling values of financial institution customer behaviors in the anonymous financial institution customer profile data as a function of the non-anonymous financial institution customer account information and non-anonymous financial institution customer credit bureau data.

5. The method of claim 4, wherein modeling the values of the financial institution customer behaviors further comprises modeling values of financial institution customers' spend and lend behaviors with the plurality of transaction card issuers other than the financial institution.

6. The method of claim 5, wherein modeling the values of the financial institution customers' spend behaviors further comprises modeling the values of the financial institution customers' spend behaviors consisting of financial institution customers' total spend with the plurality of transaction card issuers other than the financial institution, financial institution customers' spend in categories consisting of everyday, travel, retail, online, and foreign spend with the plurality of transaction card issuers other than the financial institution, and financial institution customers' spend with airline co-branded products, other co-branded products, reward products, and non-reward products with the plurality of transaction card issuers other than the financial institution.

7. The method of claim 5, wherein modeling the values of the financial institution customers' lend behaviors further comprises modeling the values of the financial institution customers' lend behaviors consisting of financial institution customers' total revolving balance with the plurality of transaction card issuers other than the financial institution, financial institution customers' amount of revolving balance by promotional rate, full rate, and higher rate with the plurality of transaction card issuers other than the financial institution, financial institution customer' estimated annual percentage rate of revolving balance with the plurality of transaction card issuers other than the financial institution, and financial institution customers' total revolving balance with airline co-branded products, other co-branded products, rewards products, and non-rewards products with the plurality of transaction card issuers other than the financial institution.

8. The method of claim 1, wherein generating the estimated spend and balance behaviors further comprises generating estimated spend, lend, and value proposition behaviors for said at least one financial institution customer with the plurality of transaction card issuers other than the financial institution based at least in part on said models.

9. The method of claim 1, wherein generating the estimated spend behaviors further comprises generating the estimated spend behaviors at category and value proposition level for said at least one financial institution customer with the plurality of transaction card issuers other than the financial institution based at least in part on said models.

10. The method of claim 1, wherein generating the estimated balance behaviors further comprises generating estimated lend behaviors by price point and value proposition for said at least one financial institution customer with the plurality of transaction card issuers other than the financial institution based at least in part on said models

11. The method of claim 1, wherein generating the estimated spend and balance behaviors further comprises generating the estimated spend and balance behaviors for said at least one financial institution customer with the plurality of transaction card issuers other than the financial institution based at least in part on modeling attributes derived from said at least one customer's current month and time-series non-anonymous credit bureau data.

12. The method of claim 11, wherein generating the estimated spend and balance behaviors based at least in part on said modeling attributes derived from the financial institution customer's time-series non-anonymous credit bureau data further comprises generating the estimated spend and balance behaviors for said at least one financial institution customer with the plurality of said issuers other than the financial institution based at least in part on modeling attributes derived from said at least one financial institution customer's time-series non-anonymous credit bureau data across a six months period.

13. The method of claim 12, wherein generating the estimated spend and balance behaviors based at least in part on said modeling attributes derived from said at least one financial institution customer's current month and time-series non-anonymous credit bureau data further comprises generating the estimated spend and balance behaviors based at least in part on modeling attributes consisting of said at least one financial institution customer's number of bankcards, open trades with balance greater than zero, six month minimum to maximum ratio of highest utilization of revolving trades, retail annual percentage rate on trades, and number of tradelines exceeding thirty days.

14. The method of claim 1, wherein creating financial institution marketing initiatives further comprises creating an individual marketing initiative tailored for said at least one financial institution customer based at least in part on said estimated spend and balance behaviors.

15. The method of claim 1, wherein creating the individual marketing initiative further comprises creating the individual marketing initiative for each one of a plurality of financial institution customers based at least in part on said estimated spend and balance behaviors for each one of said financial institution customers.

16. A system for optimizing marketing strategy to financial institution customers or prospective customers, comprising:
a processor coupled to memory, the processor being programmed to:
receive anonymous financial institution customer profile data consisting at least in part of anonymous transaction card account behavior information with a plurality of transaction card issuers other than the financial institution;
develop models based at least in part on the anonymous financial institution customer profile data consisting at least in part of the anonymous transaction card account behavior information with the plurality of transaction card issuers other than the financial institution and at least in part on non-anonymous financial institution customer account information and non-anonymous financial institution customer credit bureau data;
generate estimated spend and balance behaviors for at least one financial institution customer with the plurality of transaction card issuers other than the financial institution based at least in part on said models; and
create financial institution marketing initiatives based at least in part on said estimated spend and balance behaviors of the at least one financial institution customer with the plurality of transaction card issuers other than the financial institution.

17. A computer implemented method of communicating to financial institution customers based on a marketing initiative which is created, comprising:
receiving, using a processor coupled to memory, anonymous financial institution customer profile data consisting at least in part of anonymous transaction card account behavior information with a plurality of transaction card issuers other than the financial institution;
developing, using the processor, models based at least in part on the anonymous financial institution customer profile data consisting at least in part of the anonymous transaction card account behavior information with the plurality of transaction card issuers other than the financial institution and at least in part on non-anonymous financial institution customer account information and non-anonymous financial institution customer credit bureau data;
generating, using the processor, estimated spend and balance behaviors for at least one financial institution customer with the plurality of transaction card issuers other than the financial institution based at least in part on said models; and
creating, using the processor, financial institution marketing initiatives based at least in part on said estimated spend and balance behaviors of the at least one financial institution customer with the plurality of transaction card issuers other than the financial institution.
